(19) United States
(12) Patent Application Publication
(10) Pub. No.: US 2009/0025858 A1
(43) Pub. Date: Jan. 29, 2009

(54) Manufacturing Method of Pneumatic Tire

(75) Inventor: Masahiro Segawa, Osaka (JP)

Correspondence Address: FISH & RICHARDSON P.C., P.O. BOX 1022, MINNEAPOLIS, MN, 55440-1022, US

(73) Assignee: Toyo Tire & Rubber Co., Ltd., Osaka (JP)

(21) Appl. No.: 12/173,918

(22) Filed: Jul. 16, 2008

(30) Foreign Application Priority Data
Jul. 26, 2007 (JP) 2007-194671

(51) Int. Cl. B29D 30/32

(52) U.S. Cl. 156/132

(57) ABSTRACT

A side surface of an apex rubber is exposed annularly by injection molding the annular apex rubber and opening a forming mold while retaining the annular apex rubber in an unvulcanized state. Further, a side surface of a rubber pad is exposed annularly by injection molding the annular rubber pad and opening a forming mold while retaining the annular rubber pad in an unvulcanized state. Thereafter, an integrated compound rubber member is formed by overlapping a lower mold retaining the apex rubber and a lower mold retaining the rubber pad and laminating the side surface of the apex rubber to the side surface of the rubber pad, and an unvulcanized tire is formed by laminating the compound rubber member to the carcass ply.

### FIELD OF THE INVENTION

The present invention relates to a manufacturing method of a pneumatic tire including a step of forming an unvulcanized tire (green tire) by laminating a plurality of rubber members on a carcass ply formed as a tubular shape.

### DESCRIPTION OF THE RELATED ART

A pneumatic tire is a rubber compound constructed by laminating various rubber members to inner and outer sides of a framework constituted by a carcass ply, and a plurality of rubber members are laminated to a tubular formed carcass ply at manufacturing line in a manufacturing step, whereby an unvulcanized tire is formed. These rubber members include a rubber member which is wound around a forming drum or a carcass ply online so as to be formed as an annular shape or a cylindrical shape, and a rubber member which is previously formed as an annular shape in accordance with an offline manufacturing so as to be fed to a manufacturing line at a necessary timing.

The rubber member which can be manufactured offline as mentioned above has been conventionally manufactured by turning an extruded product molded by an extruder on a turn table so as to be formed as an annular shape, and cutting the extruded product at a predetermined length so as to join end portions. However, in this method, since the joint portion becomes locally thick due to a superposition or a close contact between the end portions, a shape of the rubber member becomes non-uniform in a circumferential direction, and there is a problem that a uniformity of a tire is lowered.

On the contrary, there has been known a so-called ribbon winding construction method of manufacturing an annular rubber member by spirally winding a narrow rubber ribbon, as disclosed in Japanese Unexamined Patent Publication No. 2004-338626. However, in accordance with this method, although a shape uniformity of the rubber member is improved, a winding man hour is increased and a forming time becomes long. In addition, there is a problem that a crack tends to be generated along an interface of the rubber ribbon.

Further, as disclosed in the following Japanese Unexamined Patent Publication No. 2006-248037, there can be considered to utilize an injection molding method. The patent document describes a method of forming an annular bead filler or a side wall rubber by injection pouring an unvulcanized rubber composition material into a cavity of a forming mold, and releasing the bead filler or the side wall rubber from the forming mold by using a coating member (a tray). In accordance with the method mentioned above, it is possible to widely shorten the forming time in comparison with the extrusion molding method and the ribbon winding construction method, and it is further possible to secure a shape uniformity of the rubber member comparatively well.

In this case, as the rubber member which can be manufactured offline, various rubber members exist in addition to the bead filler. For example, in a double bead type tire shown in FIG. 1, an annular evaginating portion 10 is constructed by a plurality of annular rubber members, which can be manufactured offline. However, even in the case that these rubber members are manufactured offline, a step of positioning and laminating the rubber members online is necessary in correspondence to a number of the members. Therefore, it has been found that there is still room for improvement in a point of a forming precision and a production efficiency of the tire.

### SUMMARY OF THE INVENTION

The present invention is made by taking the actual condition mentioned above into consideration, and an object of the present invention is to provide a manufacturing method of a pneumatic tire which can shorten a forming time so as to improve a production efficiency while securing a forming precision of a tire.

The object can be achieved by the following present invention. That is, the present invention provides a manufacturing method of a pneumatic tire including a step of forming an unvulcanized tire by laminating a plurality of rubber members to a tubular shaped carcass ply, comprising:

a first step of forming an annular first rubber member by injection filling an unvulcanized rubber compound material to a cavity of a first forming mold, and opening the first forming mold while retaining the first rubber member in an unvulcanized state so as to annularly expose a side surface of the first rubber member;

a second step of forming an annular second rubber member by injection filling an unvulcanized rubber compound material to a cavity of a second forming mold, and opening the second forming mold while retaining the second rubber member in an unvulcanized state so as to annularly expose a side surface of the second rubber member;

a third step of overlapping a mold part of the first forming mold retaining the first rubber member and a mold part of the second forming mold retaining the second rubber member, after the first step and the second step, thereby laminating the exposed side surface of the first rubber member to the side surface of the second rubber member so as to form an integrated compound rubber member; and

a fourth step of laminating the compound rubber member to the carcass ply.

The present invention is structured by forming the annular compound rubber member in accordance with the first to third steps mentioned above, and laminating the annular compound rubber member to the carcass ply in accordance with the fourth step mentioned above. The compound rubber member can be manufactured offline, and the present invention can secure a forming precision of the tire by precisely forming the rubber member which can be manufactured offline, and can improve a production efficiency of the tire by efficiently carrying out the lamination of the rubber member to the carcass ply.

In other words, in accordance with the conventional manufacturing method, the injection molded rubber member is released from the mold as a single product, and is fed to the manufacturing line singly so as to be laminated. On the contrary, in accordance with the present invention, since the first rubber member and the second rubber member are fed as the integrated compound rubber member, it is possible to simplify the laminating work in the manufacturing line, and it is possible to shorten the forming time of the tire so as to improve the production efficiency. Further, since the first rubber member and the second rubber member are laminated by overlapping the mold parts of the forming molds retaining the first and second rubber members, a positioning precision is improved in comparison with the case that the rubber members are laminated after being released from the mold, and it is possible to secure a forming precision of the tire.

Further, in the present invention, since the first and second rubber members are obtained by the injection molding, an excellent shape uniformity can be obtained, and a uniformity of the tire can be well secured. Further, since the first and second rubber members are retained in the unvulcanized state, an adhesive property of the compound rubber member with respect to the carcass ply is improved, an over vulcanization is not generated at a time of vulcanizing the tire. In this case, “unvulcanized state” indicates a state in which the vulcanization is not carried out, however, is not limited to a state in which the vulcanizing reaction does not make progress at all, but includes a semi-vulcanized state and a state corresponding to an under-vulcanization (a vulcanized state which does not reach an optimum vulcanization) defined by JISK6200.

In the above method, it is preferable that the carcass ply in the fourth step is in a state in which a center portion is evaginated to an outer side in a diametrical direction and an end portion is wound up. Therefore, it is possible to preferably secure the forming precision of the tire while suppressing the shape change of the compound rubber member.

The present invention is particularly useful in the case that the first and second rubber members are constituted by the annular evaginating portion formed so as to evaginated to an outer side in the tire width direction of a bead portion. Because the annular evaginating portion tends to include a lot of parts, and there is a tendency that the man hour is increased in accordance with the conventional manufacturing method and the tire forming work is complicated, however, the present invention mentioned above can shorten the forming time so as to improve the production efficiency.

### BRIEF DESCRIPTION OF THE DRAWINGS

FIG. 1 is a half cross sectional view of a tire meridian line showing an example of a pneumatic tire manufactured by the present invention;

FIGS. 2(a) to 2(c) are cross sectional views schematically showing a state in which the pneumatic tire is manufactured;

FIGS. 3(a) to 3(c) are cross sectional views schematically showing a state in which an apex rubber is formed;

FIG. 4 is a cross sectional view schematically showing a state after forming a rubber pad; and

FIG. 5 is a cross sectional view schematically showing a state in which a compound rubber member is formed.

### DETAILED DESCRIPTION OF THE PREFERRED EMBODIMENTS

An embodiment of the present invention will be explained with reference to the drawings.

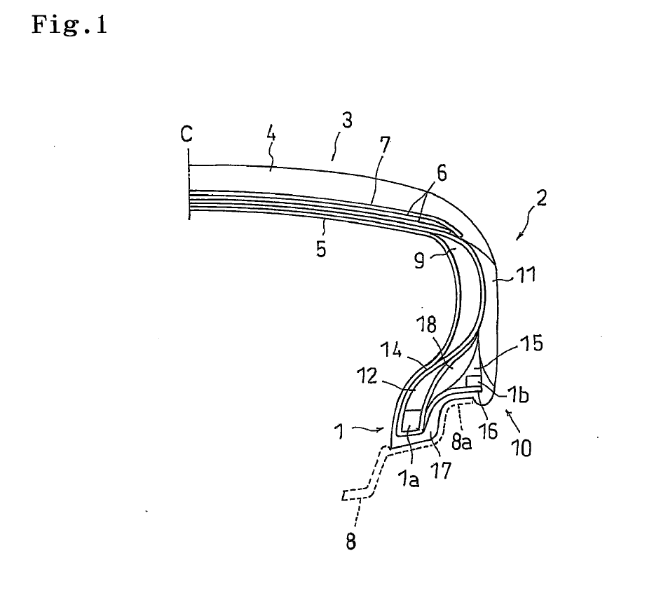

FIG. 1 is a half cross sectional view of a tire meridian line showing one example of a pneumatic tire manufactured by the present invention. The pneumatic tire comprises a pair of bead portions 1, sidewall portions 2 extending from respective bead portions 1 radially outward of the tire, and a tread portion 3 provided between the sidewall portions 2. In the bead portion 1, there are arranged an annular bead 1a constituted by a convergence body of bead wire consists of a steel wire or the like, and a bead filler 12 formed as a triangular cross sectional shape in an outer side in a tire diametrical direction of the bead 1a, and an end portion of a carcass ply 14 is wound up to an outer side in such a manner as to pinch them.

An inner liner rubber 5 for retaining a pneumatic pressure is arranged in an inner peripheral side of the carcass ply 14. Further, a rim strip rubber 17 is arranged in an outer periphery of the bead portion 1 of the carcass ply 14, and a side wall rubber 11 is arranged in an outer side of the side wall portion 2 of the carcass ply 14. Further, a belt 6 and a belt reinforcing member 7 for reinforcing on the basis of a hoop effect are arranged in an outer peripheral side of the tread portion 3 of the carcass ply 14, and a tread rubber 4 is arranged further in an outer peripheral side thereof. The carcass ply 14 is constituted by a ply cord extending approximately at an angle of 90 degree with respect to a tire equator C. Steel and an organic fiber such as a polyester, a rayon, a nylon, an aramid or the like can use for the ply cord.

The pneumatic tire is a run-flat tire which can travel even in the case that an internal pressure is lowered by a puncture or the like, and a reinforcing rubber pad 9 having a crescent cross sectional shape is arranged in an inner side of the side wall portion 2. The reinforcing rubber pad 9 has a function of supporting the tire having a lowered internal pressure so as to prevent the tire from being completely flattened, and is constructed, for example, by a rubber member having a rubber hardness between 65 and 90 degree obtained by measuring on the basis of a type A durometer hardness test of JISK6253. The pneumatic tire manufactured by the present invention is not limited to the run-flat tire.

Further, the pneumatic tire has an annular evaginating portion 10 formed so as to evaginated to an outer side in the tire width direction of the bead portion 1, and is constituted by a double bead type run-flat tire in which a bead 1b is arranged in the annular evaginating portion 10. In the tire mentioned above, since the annular evaginating portion 10 reinforced by the bead 1b is pressed to a rim flange 8a at a time of traveling in a run-flat state, the bead portion 1 is prevented from falling away from a rim 8. The bead 1b is not limited to be constituted by a converged body of the same bead wires as the bead 1a, but may be constituted, for example, by a converged body of organic fibers, a rubber bead having a fiber reinforced rubber as a raw material, and the like.

The annular evaginating portion 10 evaginates to an outer side in the tire width direction than the rim flange 8a, and has an inner peripheral surface extending along an outer peripheral side curved surface of the rim flange 8a. The inner peripheral surface is structured by a rim strip rubber 17 which is excellent in a wear resistance, and is structured in the present embodiment such that a reinforcing layer 16 constituted by a chafer or the like is arranged along the inner peripheral surface. Further, in the annular evaginating portion 10, there are arranged an apex rubber 15 arranged in an outer side in a tire diametrical direction of the bead 1b so as to be formed as a triangular cross sectional shape, and a rubber pad 18 arranged adjacent to a wound-up end portion of the carcass ply 14. The annular evaginating portion 10 may be formed in at least one bead portion 1, and may be formed only in a side forming an outer side of a vehicle at a time of installing.

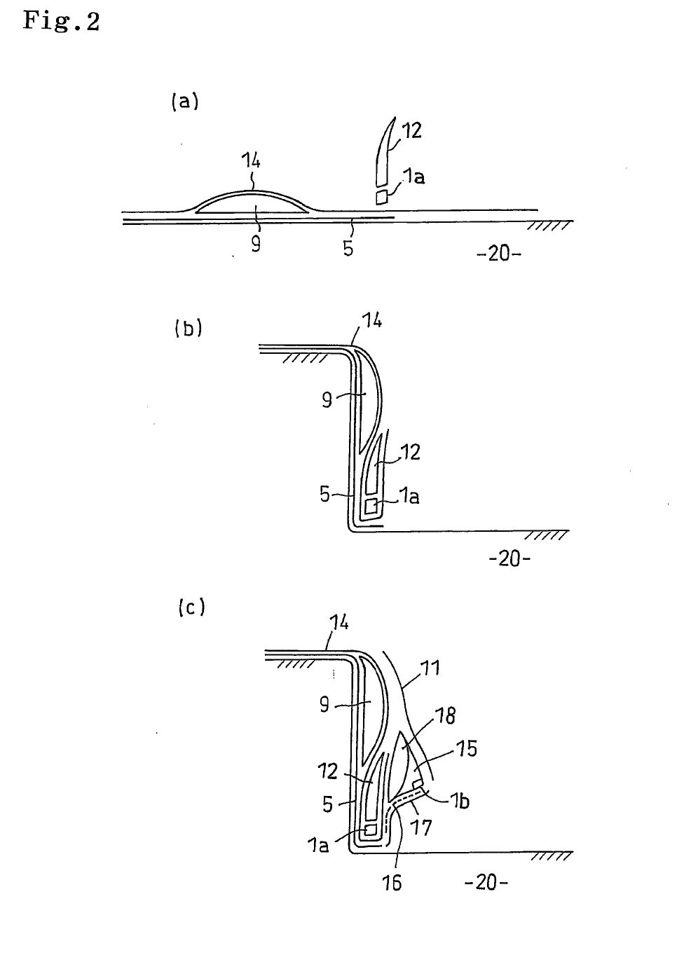

A description will be given below of a method of manufacturing the pneumatic tire. FIGS. 2(a) to 2(c) are cross sectional views schematically showing a state in which the pneumatic tire is manufactured.

First, as shown in FIG. 2(a), in a state in which an inner liner rubber 5 and the reinforcing rubber pad 9 are wound around an outer peripheral surface of a forming drum 20, and the reinforcing rubber pad 9 is wound on the inner liner rubber 5, these elements are formed as a cylindrical shape. Subsequently, the carcass ply 14 is arranged in an outer peripheral side thereof so as to be formed as a tubular shape, and the bead 1a and the bead filler 12 which have been previously formed as an annular shape offline are outside inserted to a predetermined position.

Next, as shown in FIG. 2(b), an end portion of the carcass ply 14 is wound up via the bead 1a, and the bead 1a and the bead filler 12 are sandwiched. The winding-up motion mentioned above may be carried out by a manual work, however, can be carried out by a bladder (not shown). Further, about that time or at the same time of winding up the end portion, a center portion (a left side portion in FIG. 2) of the carcass ply 14 is deformed so as to evaginated to the outer side in the diametrical direction. The evaginating deformation mentioned above can be achieved by an expanding mechanism (not shown) such as a expandable rigid core, a bladder or the like which is arranged in an inner peripheral side of the center portion of the carcass ply 14, while fixing the bead 1a by a known bead lock mechanism (not shown) and displacing them so as to come close to each other.

Next, as shown in FIG. 2(c), the bead 1b, the apex rubber 15 and the rubber pad 18 for constructing the annular evaginating portion 10 are laminated to a side portion of the carcass ply 14, and the reinforcing layer 16, the rim strip rubber 17 and the side wall rubber 11 are laminated to an outer side thereof. The rim strip rubber 17 and the side wall rubber 11 can be laminated by winding up them utilizing the bladder (not shown). Thereafter, an unvulcanized tire is formed by further evagination deforming the carcass ply 14, and laminating it to an inner peripheral surface of a tread member (not shown) arranged in an outer peripheral side thereof. The tread member corresponds to a cylindrical member manufactured by integrating the tread rubber 4, the belt 6 and the belt reinforcing member 7 in a different step.

The step of forming the unvulcanized tire as mentioned above is carried out on the forming drum 20, and comes to an online work, however, the apex rubber 15 and the rubber pad 18 can be previously formed as an annular shape in accordance with an off line manufacturing, and can be fed to a manufacturing line at a necessary timing so as to be laminated to the carcass ply 14. A description will be given below of a step from forming the apex rubber 15 and the rubber pad 18 until reaching the lamination of them. In the present embodiment, the apex rubber 15 corresponds to the first rubber member, and the rubber pad 18 corresponds to the second rubber member.

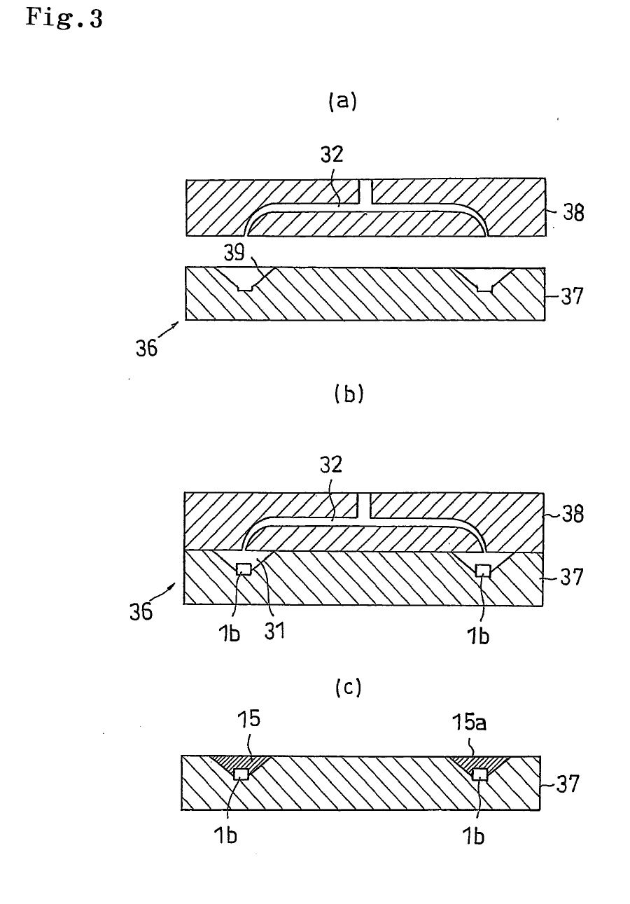

FIGS. 3(a) to 3(c) are cross sectional views schematically showing a state in which the apex rubber 15 is formed. A forming mold 36 (corresponding to the first forming mold) is provided with a lower mold 37 in which an annular concave groove 39 is formed on an upper surface, and an upper mold 38 arranged in an upper side of the lower mold 37, and is structured such as to be openable and closable by relatively moving up and down the lower mold 37 with respect to the upper mold 38. The bead 1b is arranged in a bottom portion of the annular concave groove 39 as shown in FIG. 3(b), and a cavity 31 having a shape corresponding to the apex rubber 15 is formed in an interface of both the molds 37 and 38 by clamping the mold.

In the upper mold 38, there is formed a feed path 32 constituted by a sprue extending toward a lower side from a center of the upper surface, a runner extending so as to branch into both sides in a width direction from the sprue, and a gate extending from an end portion of the runner while making a cross sectional area small. The upper mold 38 is structured such that an unvulcanized rubber composition material can be injection poured to the cavity 31 from an injection mechanism (not shown). Further, a temperature control mechanism (not shown) is provided in the forming mold 36, and is structured such as to control a temperature, a temperature control timing and the like.

In the present embodiment, the apex rubber 15 is formed in the manner mentioned below. In other words, the annular apex rubber 15 is integrally formed with the bead 1b by arranging the bead 1b in the annular concave groove 39 of the lower mold 37, thereafter clamping the forming mold 36 as shown in FIG. 3(b), and injection filling an unvulcanized rubber compound material into the cavity 31 formed in the inner portion. Subsequently the forming mold 36 is opened while retaining the formed apex rubber 15 in an unvulcanized state, and a side surface 15a of the apex rubber 15 is exposed annularly as shown in FIG. 3(c) (corresponding to the first step).

In the description mentioned above, the forming mold 36 at a time of injection pouring the unvulcanized rubber composition material is heated and retained at such a degree of temperature as to secure a fluidity of the unvulcanized rubber composition material. The temperature may be lower than a vulcanizing temperature, or may be set to the vulcanizing temperature in the same manner as the conventional injection molding. The forming mold 36 is mold released while the apex rubber 15 is in the unvulcanized state, and the forming mold 36 may be cooled as occasion demands in such a manner as to prevent the vulcanization from making progress.

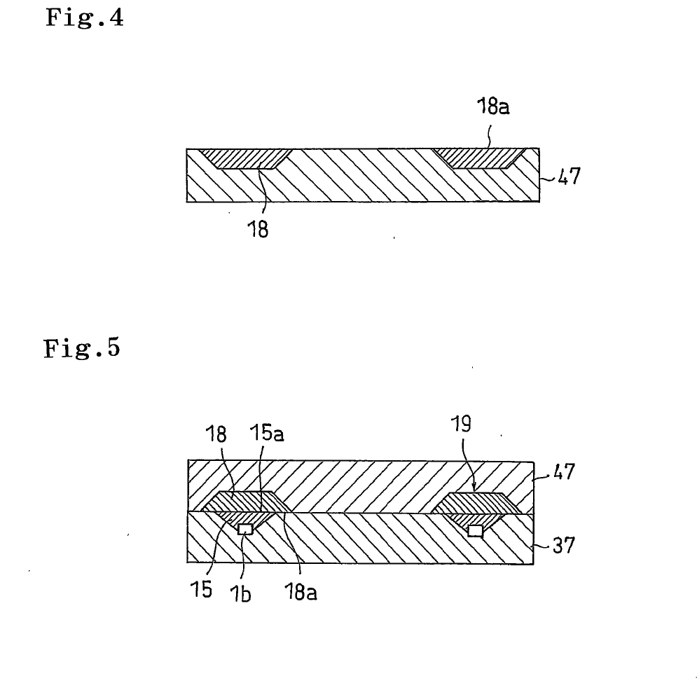

The rubber pad 18 can be formed by the same step as that of the apex rubber 15. In other words, the rubber pad 18 is formed by injection filling the unvulcanized rubber compound material into a cavity by using a forming mold (not shown) (corresponding to the second forming mold) in which the cavity having a shape corresponding to the rubber pad 18 is formed, and a side surface 18a of the rubber pad 18 is exposed annularly (corresponding to the second step) as shown in FIG. 4, by opening the forming mold while retaining the rubber pad 18 in the unvulcanized state. In the formation of the apex rubber 15 and the formation of the rubber pad 18, whichever may be carried out in advance.

An annular compound rubber member 19 is formed by forming the apex rubber 15 and the rubber pad 18, thereafter overlapping the lower mold 37 (corresponding to the mold part of the first forming mold retaining the first rubber member) retaining the apex rubber 15, and the lower mold 47 (corresponding to the mold part of the second forming mold retaining the second rubber member) retaining the rubber pad 18, as shown in FIG. 5, and laminating the exposed side surface 15a of the apex rubber 15 to the exposed side surface 18a of the rubber pad 18 so as to integrate (corresponding to the third step mentioned above).

In the present embodiment, the lower mold 47 retaining the rubber pad 18 is inverted up and down so as to be overlapped, at a time of laminating the side surfaces of the apex rubber 15 and the rubber pad 18 to each other. Since the rubber pad 18 under the unvulcanized state has a high adhesive characteristic and is closely attached to the lower mold 47, the rubber pad 18 does not fall away from the lower mold 47 even if the rubber pad 18 is inverted as mentioned above. In this case, in order to more securely prevent the rubber pad 18 from falling away, a suction cup effect may be increased by making a surface roughness of the annular concave groove of the lower mold 47 small, or the rubber pad 18 may be sucked and retained through a suction hole communicated with the bottom surface of the annular concave groove. Further, the lower mold 37 and the lower mold 47 may be set to a rising posture obtained by rotating at 90 degrees so as to be lapped over each other.

The compound rubber member 19 formed as mentioned above is fed to the manufacturing line under the state in FIG. 2(b) at a necessary timing, and is laminated to the carcass ply 14 as shown in FIG. 2(c) (corresponding to the fourth step mentioned above). Since the compound rubber member 19 is formed by laminating the injection molded apex rubber 15 and rubber pad 18 in a state of being retained by the lower molds 37 and 47, a positioning precision can be improved in comparison with the case of being laminated after the mold release as well as being excellent in a shape uniformity, and it is possible to well secure a uniformity of the tire. Since the compound rubber member 19 is retained in the unvulcanized state, the compound rubber member 19 has a good adhesive property with respect to the carcass ply 14, and an over vulcanization is not generated at a time of vulcanizing the tire.

The compound rubber member 19 picked up from the lower mold 37 and the lower mold 47 may be laminated to the carcass ply 14, however, it is preferable to feed the compound rubber member 19 to the manufacturing line so as to laminate to the carcass ply 14 while retaining the compound rubber member 19 by the lower mold 37 by removing only the lower mold 47 from the state in FIG. 5. Accordingly, it is possible to precisely and easily position the compound rubber member 19 with respect to the carcass ply 14. The compound rubber member 19 can be smoothly picked up from the lower mold 37 by knocking up the bead 1b, for example, by utilizing an eject pin.

In the case of respectively preparing the apex rubber 15 and the rubber pad 18 as single parts, and sequentially feeding them to the manufacturing line, it is necessary to position and laminate the rubber pad 18 on the basis of the work on the forming drum 20, that is, an online work, and subsequently position and laminate the apex rubber 15, however, in accordance with the present embodiment, it is sufficient to position and laminate the compound rubber member 19 on the forming drum 20. Accordingly, it is possible to simplify the laminating work on the manufacturing line, and it is possible to shorten the forming time of the tire so as to improve a production efficiency.

The manufacturing method of the pneumatic tire in accordance with the present invention is the same as the conventional method except the step of laminating the compound rubber member to the carcass ply as mentioned above at a time of forming the unvulcanized tire, and the known tire forming step can be appropriately employed without being limited to the step shown in FIG. 2. In this case, it is preferable that the carcass ply at a time when the compound rubber member are laminated is in a state in which the center portion is evaginated to the outer side in the diametrical direction and the end portion is wound up, such as the embodiment mentioned above. Therefore, it is possible to preferably secure the forming precision of the tire while suppressing the shape change of the compound rubber member. The structure of the pneumatic tire manufactured in accordance with the present invention is not limited to the structure shown in FIG. 1, and the material and the shape thereof are not particularly limited.

The present invention is particularly useful in the case that the rubber member coming to the compound rubber member is constituted by the rubber member constructing the annular evaginating portion, such as the embodiment mentioned above. Because the annular evaginating portion tends to include a lot of parts, and there is a tendency that the man hour is increased in accordance with the conventional manufacturing method and the tire forming work is complicated, however, the present invention can shorten the forming time so as to improve the production efficiency. In this case, the present invention is not limited to this. For example, in the tire installed to a motor truck or the like, since a buttress portion and a bead periphery are constructed by a plurality of rubber members, it is possible to laminate them as the compound rubber member as mentioned above. Further, the structure may be made such that an annular multilayer rubber member is formed by injection filling a different kind of unvulcanized rubber compound material into the cavity of the forming mold, and the compound rubber member is formed by using the annular multilayer rubber member.

What is claimed is:

1. A manufacturing method of a pneumatic tire including a step of forming an unvulcanized tire by laminating a plurality of rubber members to a tubular shaped carcass ply, comprising:
a first step of forming an annular first rubber member by injection filling an unvulcanized rubber compound material to a cavity of a first forming mold, and opening the first forming mold while retaining the first rubber member in an unvulcanized state so as to annularly expose a side surface of the first rubber member;
a second step of forming an annular second rubber member by injection filling an unvulcanized rubber compound material to a cavity of a second forming mold, and opening the second forming mold while retaining the second rubber member in an unvulcanized state so as to annularly expose a side surface of the second rubber member;
a third step of overlapping a mold part of the first forming mold retaining the first rubber member and a mold part of the second forming mold retaining the second rubber member, after the first step and the second step, thereby laminating the exposed side surface of the first rubber member to the side surface of the second rubber member so as to form an integrated compound rubber member; and
a fourth step of laminating the compound rubber member to the carcass ply.

2. The manufacturing method of a pneumatic tire according to claim 1, wherein the carcass ply in the fourth step is in a state in which a center portion is evaginated to an outer side in a diametrical direction and an end portion is wound up.

3. The manufacturing method of a pneumatic tire according to claim 1, wherein the first rubber member and the second rubber member construct an annular evaginating portion formed so as to evaginated to an outer side in a tire width direction of a bead portion.
